(19) United States
(12) Patent Application Publication
(10) Pub. No.: US 2013/0162083 A1
(43) Pub. Date: Jun. 27, 2013

(54) SPINDLE MOTOR

(71) Applicant: SAMSUNG ELECTRO-MECHANICS CO., LTD., Suwon (KR)

(72) Inventors: Yong Sik Kim, Suwon (KR); Ho Kyung Jang, Suwon (KR); Sang Won Kim, Suwon (KR); II Oung Park, Suwon (KR)

(73) Assignee: SAMSUNG ELECTRO-MECHANICS CO., LTD., Suwon (KR)

(21) Appl. No.: 13/706,754

(22) Filed: Dec. 6, 2012

(30) Foreign Application Priority Data
Dec. 23, 2011 (KR) 10-2011-0140917

(51) Int. Cl. H02K 7/08; H02K 15/00

(52) U.S. Cl. CPC H02K 7/086; H02K 15/00
USPC 310/90; 427/58

(57) ABSTRACT

Disclosed herein is a spindle motor including a shaft forming a rotation center of the motor; a sleeve receiving the shaft therein and rotatably supporting the shaft; a thrust plate coupled to the sleeve in a direction vertical to an axial direction, wherein the thrust plate includes a friction reducing coating layer formed thereon. According to the present invention, the coating layer for reducing friction force is formed on the thrust plate of the spindle motor, such that friction force generated when the spindle motor is repeatedly and sequentially stopped, operated, and stopped may be effectively reduced, such that operational performance of the spindle motor may be improved.

### CROSS REFERENCE TO RELATED APPLICATION

This application claims the benefit of Korean Patent Application No. 10-2011-0140917, filed on Dec. 23, 2011, entitled “Spindle Motor”, which is hereby incorporated by reference in its entirety into this application.

### BACKGROUND OF THE INVENTION

1. Technical Field

The present invention relates to a spindle motor.

2. Description of the Related Art

Generally, a spindle motor, which belongs to a brushless-DC motor (BLDC), has been widely used as a laser beam scanner motor for a laser printer, a motor for a floppy disk drive (FDD), a motor for an optical disk drive such as a compact disk (CD) or a digital versatile disk (DVD), or the like, in addition to a motor for a hard disk drive.

Recently, in a device such as a hard disk drive requiring high capacity and high speed driving force, in order to minimize generation of noise and non-repeatable run out (NRRO) which is vibration generated at the time of use of a ball bearing, a spindle motor including a fluid dynamic pressure bearing having lower driving friction as compared to an existing ball bearing has generally been used. In the fluid dynamic pressure bearing, a thin oil film is basically formed between a rotor and a stator, such that the rotor and the stator are supported by pressure generated at the time of rotation. Therefore, the rotor and stator are not in contact with each other, such that frictional load is reduced. In the spindle motor using the fluid dynamic pressure bearing, lubricating oil (hereinafter, referred to as an ‘operating fluid’) maintains a shaft of the motor rotating a disk only with dynamic pressure (pressure returning oil pressure to the center by centrifugal force of the shaft). Therefore, the spindle motor using the fluid dynamic pressure bearing is distinguished from a ball bearing spindle motor in that the shaft is supported by a shaft ball made of iron.

When the fluid dynamic pressure bearing is used in the spindle motor, the rotor is supported by the fluid, such that a noise amount generated in the motor is small, power consumption is low, and impact resistance is excellent.

In a hard disk drive (HDD) motor according to the prior art, recently, a structure in which a thrust plate is used in order to support rigidity of a thrust bearing is generally used. In this structure, in the case in which the motor is switched from a stop state to an operation state, stiction, which is the largest friction, is generated between the thrust plate and a surface in which a thrust dynamic pressure generation groove supporting the thrust plate is formed. In the case in which this friction force is repeatedly generated, abrasion particles by the friction force may be generated. In this structure in which the friction force is frequently generated when the spindle motor is repeatedly and sequentially stopped, operated, and stopped, operational lifespan of the motor may be reduced. In addition, operational performance of the spindle motor may be deteriorated due to repetitive generation of this friction force, and driving reliability may be deteriorated.

### SUMMARY OF THE INVENTION

The present invention has been made in an effort to provide a spindle motor including a coating layer capable of reducing the friction force on a thrust plate so that friction force generated when the spindle motor is repeatedly stopped and operated may be reduced.

According to a preferred embodiment of the present invention, there is provided a spindle motor including: a shaft forming a rotation center of the motor; a sleeve receiving the shaft therein and rotatably supporting the shaft; a thrust plate coupled to the sleeve in a direction vertical to an axial direction; wherein the thrust plate includes a friction reducing coating layer formed thereon.

The friction reducing coating layer may be formed on the thrust plate facing the sleeve.

The friction reducing coating layer may be formed by a self-assembled monolayer (SAM) coating method.

The friction reducing coating layer may be formed by a method including: removing organic materials from the surface of the thrust plate in a hexane solution; performing surface-treatment in a piranha solution for surface activation of the thrust plate; dipping the thrust plate into a solution obtained by diluting an octadecyltrichlorosilane (OTS) SAM solution with a hexadecane solution at a concentration of 1 mM to coat the surface thereof; removing residues from the thrust plate with an isopropyl alcohol (IPA) solution; and washing the thrust plate with de-ionized (DI) water.

The method may further include removing the organic material from the surface of the thrust plate in the IPA solution, after the removing of the organic materials from the surface of the thrust plate in the hexane solution.

The friction reducing coating layer may be formed by a method including: removing organic materials from the surface of the thrust plate in a hexane solution; performing surface-treatment in a piranha solution for surface activation of the thrust plate; dipping the thrust plate into a solution obtained by diluting an 1H,1H,2H,2H-Perflurodecyltrichlorosilane (FDTS) SAM solution with an iso-octane solution at a concentration of 1 mM to coat the surface thereof; removing residues from the thrust plate with an IPA solution; and washing the thrust plate with DI water.

The method may further include removing the organic material from the surface of the thrust plate in the IPA solution, after the removing of the organic materials from the surface of the thrust plate in the hexane solution.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view of a spindle motor including a thrust plate according to a preferred embodiment of the present invention;

FIG. 2 is a perspective view of a thrust plate including a coating layer formed thereon according to the preferred embodiment of the present invention; and

FIG. 3 is a cross-sectional view taken along the line A-A′ of FIG. 2.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

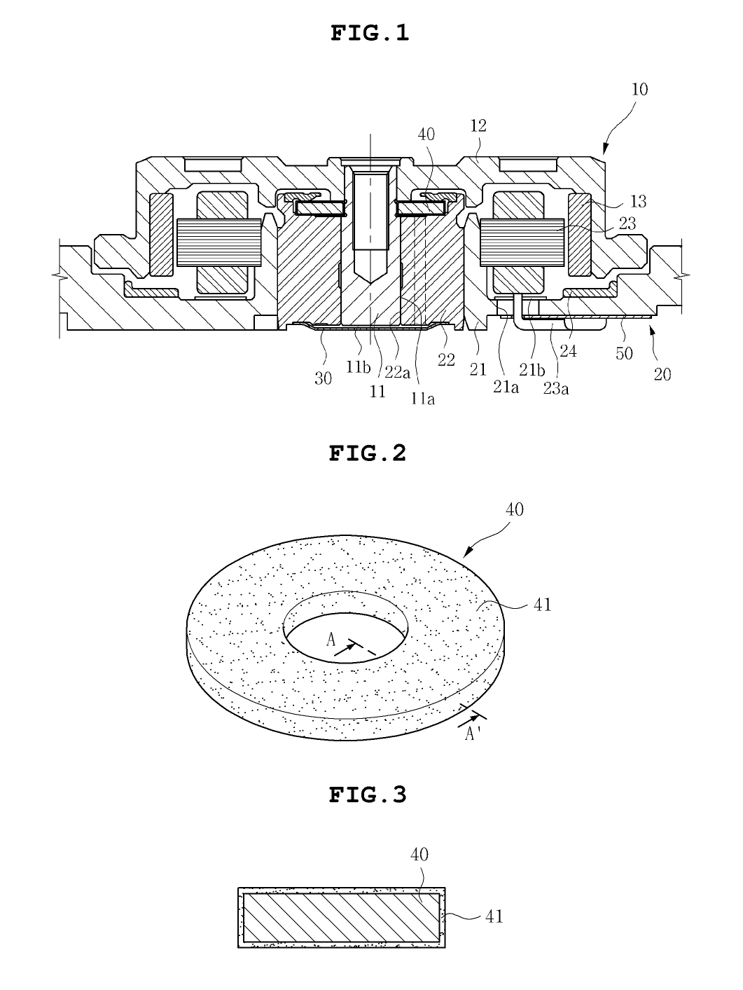

FIG. 1 is a cross-sectional view of a spindle motor including a thrust plate according to a preferred embodiment of the present invention, FIG. 2 is a perspective view of a thrust plate including a coating layer formed thereon according to the preferred embodiment of the present invention; and FIG. 3 is a cross-sectional view taken along the line A-A′ of FIG. 2.

The spindle motor according to the preferred embodiment of the present invention includes a shaft 11 forming a rotation center of the motor, a sleeve 22 receiving the shaft 11 therein and rotatably supporting the shaft 11, a thrust plate 40 coupled to the sleeve 22 in a direction vertical to an axial direction, wherein the thrust plate 40 includes a friction reducing coating layer 41 formed thereon.

As shown in FIGS. 2 and 3, the friction reducing coating layer 41 may be formed on the trust plate 40 facing the sleeve 22 and formed on the entire surface thereof. The friction reducing coating layer 41 is formed by a self-assembled monolayer (SAM) coating method.

In the spindle motor including the fluid dynamic pressure bearing according to the preferred embodiment of the present invention, the friction reducing coating layer 41 is formed on the thrust plate 40 forming a thrust dynamic pressure bearing part, such that the entire friction force may be reduced. Generally, the thrust plate 40 is made of zirconium oxide (ZrO₂), which is a ceramic material. In order to adjust a thickness and a surface-roughness after sintering, a surface is manufactured by a polishing process, such that the thrust plate 40 has a fine surface-roughness of about 0.035 μm or less. The thrust plate 40 in a stop state of the spindle motor contacts the thrust dynamic pressure generation groove corresponding to the thrust plate 40, and friction force is generated at the time of rotation of the spindle motor. Therefore, when the spindle motor is switched form the stop state to the operation state, abrasion particles by the friction force are generated, which may have a vital influence on the lifespan of the motor.

The present invention is to extend and improve the lifespan of the motor by forming the friction reducing coating layer 41 on the thrust plate 40 to reduce the abrasion particles by the friction force generated according to driving of the spindle motor as described above. As shown in FIG. 1, the fluid dynamic pressure bearing part is formed at surfaces at which the thrust plate 40 and the sleeve 22 face each other, and the friction force may be generated at the time of switching between the stop state and the operation state of the spindle motor by the dynamic pressure generation groove formed in a surface of the sleeve 22 facing the thrust plate 40. However, the friction reducing coating layer 41 is formed on the thrust plate 40, such that this friction force is reduced, thereby making it possible to improve operational performance and reliability of the motor.

The friction reducing coating layer 41 is formed using the self-assembled monolayer (SAM) coating method. As the SAM coating method, a dipping method of dipping the thrust plate 40 in a SAM solution may be used, and the friction reducing coating layer 41 may be formed by various coating methods using the SAM solution, or the like, in addition to the dipping method.

As an example of the SAM that may be used for the SAM coating, there are octadecyltrichlorosilane (OTS) SAM (CH₃(CH₂)₁₇SiCl₃) or 1H,1H,2H,2H-Perflurodecyltichlorosilane (FDTS) SAM (CF₃(CH₂)₇(CH₂)₂SiCl₃), or the like, capable of binding to oxygen (O₂) of a ceramic surface. Since the SAM coating is generally formed to have a thin thickness of about 3 nm, there is an advantage in that the SAM coating does not have a large influence on design of the thrust plate 40.

More specifically, a method of forming the friction reducing coating layer 41 on the thrust plate 40 using the OTS SAM solution includes removing organic materials from the surface of the thrust plate 40 in a hexane solution; performing surface-treatment in a piranha solution for surface activation of the thrust plate 40; dipping the thrust plate 40 into a solution obtained by diluting the OTS SAM solution with a hexadecane solution at a concentration of 1 mM to coat the surface thereof; removing residues from the thrust plate 40 with an isopropyl alcohol solution; and washing the thrust plate 40 with de-ionized water.

First, a process of removing the organic material from the surface of the thrust plate 40 in the hexane solution is performed. In the present process, foreign materials of the thrust plate 40 are removed, such that reliability of the coating to be performed may be secured. Particularly, in order to certainly remove the residual organic material of the thrust plate 40, removing the organic material from the surface of the thrust plate 40 in the IPA solution may be further performed. Here, the IPA solution, that is, isopropyl alcohol, has a feature of dissolving non-polar materials to easily be evaporated without leaving its own stain, such that the IPA solution is a material mainly used as a cleaning solution for information technology components such as a semiconductor, liquid crystal display (LCD), or the like. Through these processes, the residual foreign materials of the surface of the thrust plate 40 may be completely removed.

Next, for surface activation of the thrust plate 40, a process of the surface treatment in the piranha solution is performed. The thrust plate 40 is dipped into the piranha solution (isooctane), such that the surface may be activated, and a chemical bond may be more easily formed.

Then, the thrust plate 40 is dipped into the solution obtained by diluting the OTS SAM solution with the hexadecane solution at a concentration of 1 mM to coat the surface thereof. Here, the OTS SAM coating is performed, such that the friction reducing coating layer 41 may be substantially formed on the surface of the thrust plate 40.

Next, the residues are removed from the thrust plate 40 with the IPA solution, and the thrust plate 40 is washed with DI water, such that the surface treatment of the thrust plate 40 is finished. Here, the de-ionized (DI) water means pure water having no impurities except for ions generated through auto-ionization of water by removing all of the ions dissolved in water. Finally, the surface of the thrust plate 40 is washed using the DI water, such that the friction reducing coating layer 41 is formed.

In addition, a method of forming the friction reducing coating layer 41 on the thrust plate 40 using the FDTS SAM solution includes removing organic materials from the surface of the thrust plate 40 in a hexane solution; performing surface-treatment in a piranha solution for surface activation of the thrust plate 40; dipping the thrust plate 40 into a solution obtained by diluting the FDTS SAM solution with the iso-octane solution at a concentration of 1 mM to coat the surface; removing residues from the thrust plate 40 with the IPA solution; and washing the thrust plate 40 with the DI water.

Here, this method is different from the method using the above-mentioned method in that the thrust plate 40 is dipped into the solution obtained by diluting the FDTS SAM solution with the iso-octane solution at a concentration of 1 mM to thereby coat the surface thereof. That is, the friction reducing coating layer 41 is formed using the FDTS SAM solution. Since other processes are overlapped with those described above, detailed descriptions thereof will be omitted.

A degree of the influence on the friction force may be represented by surface energy of a material, and it may be appreciated that the SAM coating according to the present invention is performed, such that a hydrophobic surface having surface energy lower than that of the existing thrust plate 40 not including the friction reducing coating layer 41 is formed as shown in the following Table 1.

TABLE 1

| Material kind | Surface Energy |
|---|---|
| Material according to the prior art (Zirconium | 42.04 mJ/m² |
| oxide (ZᵣO₂)) | |
| OTS SAM coating layer | 24.12 mJ/m² |
| FDTS SAM coating layer | 16.52 mJ/m² |

Since the friction force is reduced in the low surface energy as shown in Table 1, generation of the abrasion particles by the friction force may be reduced, such that driving performance and reliability of the spindle motor may be improved, thereby extending the lifespan of the spindle motor.

As shown in FIG. 1, the spindle motor according to the preferred embodiment of the present invention includes the shaft 11 becoming the rotation center of a rotor 10, the sleeve 22 receiving the shaft 11 therein and rotatably supporting the shaft 11, a base 21 coupled to an outer side surface of the sleeve 22 so as to support the sleeve 22, including a core 23 mounted on an inner side surface thereof and having a coil 23 wound therearound, and including a through hole 21a formed on a low end surface thereof through which a coil 23a penetrates in the axial direction , and a flexible printed circuit board 50 formed at a back surface of the base 21, wherein the coil 23a penetrating the through hole 21a is soldered and adhered to the flexible printed circuit board 50.

The shaft 11 forms a center axis around which the spindle motor rotates and has generally a cylindrical shape. The thrust plate 40 for forming the thrust dynamic pressure bearing part by a fluid dynamic pressure bearing may be insertedly installed so as to be orthogonal to an upper side portion of the shaft 11. Here, the thrust plate 40 may be formed at the upper side portion of the shaft 11 or be insertedly installed so as to be orthogonal to a lower end portion of the shaft 11. In order to fix the thrust plate 40 to the shaft 11, separate laser welding, or the like, may be performed. However, it is obvious to those skilled in the art that the thrust plate 40 may be press-fitted into the shaft 11 by being applied with a predetermined pressure. The dynamic pressure generation groove (not shown) may be formed in any one of facing surfaces of the thrust plate 40 and the sleeve 22 in order to form the thrust dynamic pressure bearing part by the fluid dynamic pressure bearing. Since the structure in which the friction reducing coating layer 41 formed on the thrust plate 40 according to the present invention is described above, a detailed description thereof will be omitted.

The sleeve 22 may receive the shaft 11 therein and have a hollow cylindrical shape so as to rotatably support the shaft 11, and a radial dynamic pressure bearing part by oil, which is operating fluid, may be formed in an outer peripheral surface 11a of the shaft 11 and an inner peripheral surface 22a of the sleeve 22 coupled to each other. In addition, a dynamic pressure generation groove (not shown) for generating dynamic pressure of the radial dynamic pressure bearing part may be formed in any one of the outer peripheral surface 11a of the shaft 11 and the inner peripheral surface 22a of the sleeve 22 in which the radial dynamic pressure bearing part is formed.

A hub 12, which is to mount and rotate an optical disk (not shown) or a magnetic disk (not shown) thereon, has the shaft 11 coupled integrally therewith at the center thereof and is coupled to an upper portion of the shaft 11 so as to correspond to the upper end surface of the sleeve 22 in the axial direction. A rotor magnet 13 is formed so as to face the core 23 of the base 21 to be described below in a radial direction. The core 23 generates a magnetic flux while forming a magnetic field when current flows. The rotor magnet 13 facing the core 23 includes repeatedly magnetized N and S poles to form an electrode corresponding to a variable electrode generated in the core 23. The core 23 and the rotor magnet 13 have repulsive force generated therebetween due to electromagnetic force by interlinkage of magnetic fluxes to rotate the hub 12 and the shaft 11 coupled to the hub 12.

The base 21 has one side surface coupled to an outer peripheral surface of the sleeve 22 so that the sleeve 22 including the shaft 11 is coupled to an inner side thereof. The base 21 has a core 23 coupled to the other side surface thereof, which is an opposite side to one side surface thereof, at a position corresponding to that of a rotor magnet 13 formed on the hub 12, wherein the core 23 has a winding coil 23a wound therearound. The base 21 may serve to support the entire structure of the spindle motor at a lower portion of the spindle motor and be manufactured by a press processing method or a die-casting method. In the case in which the base 21 is manufactured by the press processing method, the base 21 may be made of various metal materials such as aluminum, steel, and the like, particularly, a material having rigidity. The base 21 and the sleeve 22 may be assembled to each other by applying an adhesive to an inner surface of the base 21 or an outer surface of the sleeve 22. A conductive adhesive (not shown) for conduction between the base 21 and the sleeve 22 may be connected to and formed on a lower end surface of a portion at which the base 21 and the sleeve 22 are bonded to each other. The conductive adhesive is formed to allow excessive charges generated at the time of the operation of the motor to flow out through the base 21, thereby making it possible to improve reliability of the operation of the motor.

The core 23 is generally formed by stacking a plurality of thin metal plates and is fixedly disposed on the base 21 including a flexible printed circuit board 50. A plurality of through-holes 21a may be formed so as to correspond to the coil 23a led from the winding coil 23a, and the coil 23a led through the through-holes 21a may be soldered and electrically connected to the flexible printed circuit board 50.

A cover member 30 is coupled to the sleeve 22 in order to cover lower end surfaces of the shaft 11 and the sleeve 22 in the axial direction. The cover member 30 includes a dynamic pressure generation groove formed in an inner side surface facing the lower end surface 11b of the shaft 11, thereby making it possible to form a thrust dynamic pressure bearing part. The cover member 30 has a structure in which it is coupled to the sleeve 22 while entirely covering a lower end of the sleeve 22, such that it may store the oil, which is the operating fluid, formed in the fluid dynamic pressure bearing.

Components of the spindle motor according to the preferred embodiment of the present invention and an operation relationship therebetween will be briefly described below with reference to FIG. 1.

A rotor 10 may include the shaft 11 becoming a rotation axis and rotatably formed and a hub 12 having the rotor magnet 13 attached thereto, and a stator 20 may include the base 21, the sleeve 22, the core 23, and a pulling plate 24. Each of the core 23 and the rotor magnet 13 is attached to an outer side of the base 21 and an inner side of the hub 12 while facing each other. When current is applied to the core 23, the magnetic flux is generated while the magnetic field is formed. The rotor magnet 13 facing the core 23 includes repeatedly magnetized N and S poles to form an electrode corresponding to a variable electrode generated in the core 23. The core 23 and the rotor magnet 13 have repulsive force generated therebetween due to electromagnetic force by interlinkage of magnetic fluxes to rotate the hub 12 and the shaft 11 coupled to the hub 12, such that the spindle motor according to the preferred embodiment of the present invention is driven. In addition, in order to prevent floating at the time of driving of the motor, the pulling plate 24 is formed on the base 21 so as to correspond to the rotor magnet 13 in the axial direction. The pulling plate 24 may be made of a metal material so that attractive force acts between the pulling plate 23 and the rotor magnet 13. More specifically, the pulling plate 24 may be made of a material such as an SUS material, nickel, gold, or the like. In addition, a material of the pulling plate 24 is not limited to the above-mentioned material as long as it is a metal material having a property allowing attractive force to acts between the pulling plate 23 and the rotor magnet 13. The pulling plate 24 and the rotor magnet 13 have attractive force acting therebetween, thereby making it possible to stably rotate the motor.

According to the present invention, the coating layer for reducing the friction force is formed on the thrust plate of the spindle motor, such that lifespan of the spindle motor may be extended.

In addition, the coating layer for reducing friction force is formed on the thrust plate of the spindle motor, such that the friction force generated when the spindle motor is repeatedly and sequentially stopped, operated, and stopped may be effectively reduced, thereby making it possible to improve operational performance of the spindle motor.

Further, the coating layer for reducing friction force is formed on the thrust plate of the spindle motor, such that surface energy of the thrust plate is reduced to form a hydrophobic surface, and generation of the abrasion particles may be reduced.

Furthermore, the coating layer for reducing friction force is formed on the thrust plate of the spindle motor, such that driving reliability of the spindle motor may be secured.

In addition, since the SAM coating is used as the coating layer for reducing friction force on the thrust plate of the spindle motor, a thin friction reducing coating layer is formed, such that the coating layer may be selected and used in the existing structure of the thrust plate without a separate design change.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A spindle motor comprising:
a shaft forming a rotation center of the motor;
a sleeve receiving the shaft therein and rotatably supporting the shaft;
a thrust plate coupled to the sleeve in a direction vertical to an axial direction;
wherein the thrust plate includes a friction reducing coating layer formed thereon.

2. The spindle motor as set forth in claim 1, wherein the friction reducing coating layer is formed on the thrust plate facing the sleeve.

3. The spindle motor as set forth in claim 1, wherein the friction reducing coating layer is formed by a self-assembled monolayer (SAM) coating method.

4. The spindle motor as set forth in claim 1, wherein the friction reducing coating layer is formed by a method including:
removing organic materials from the surface of the thrust plate in a hexane solution;
performing surface-treatment in a piranha solution for surface activation of the thrust plate;
dipping the thrust plate into a solution obtained by diluting an octadecyltrichlorosilane (OTS) SAM solution with a hexadecane solution at a concentration of 1 mM to coat the surface thereof;
removing residues from the thrust plate with an isopropyl alcohol (IPA) solution; and
washing the thrust plate with de-ionized (DI) water.

5. The spindle motor as set forth in claim 4, wherein the method further includes removing the organic material from the surface of the thrust plate in the IPA solution, after the removing of the organic materials from the surface of the thrust plate in the hexane solution.

6. The spindle motor as set forth in claim 1, wherein the friction reducing coating layer is formed by a method including:
removing organic materials from the surface of the thrust plate in a hexane solution;
performing surface-treatment in a piranha solution for surface activation of the thrust plate;
dipping the thrust plate into a solution obtained by diluting an 1H,1H,2H,2H-Perflurodecyltrichlorosilane (FDTS) SAM solution with an iso-octane solution at a concentration of 1 mM to coat the surface thereof;
removing residues from the thrust plate with an IPA solution; and
washing the thrust plate with DI water.

7. The spindle motor as set forth in claim 6, wherein the method further includes removing the organic material from the surface of the thrust plate in the IPA solution, after the removing of the organic materials from the surface of the thrust plate in the hexane solution.
